(19) United States
(12) Patent Application Publication
(10) Pub. No.: US 2016/0111025 A1
(43) Pub. Date: Apr. 21, 2016

(54) Method and Device for Automatic Development of a Behavior Model of an Apparatus Providing a Cryptographic Interface

(71) Applicant: INRIA INSTITUT NATIONAL DE RECHERCHE EN INFORMATIQUE ET EN AUTOMATIQUE, Le Chesnay (FR)

(72) Inventors: Romain Bardou, Cachan (FR); Graham Steel, Paris (FR)

(21) Appl. No.: 14/897,090

(22) PCT Filed: Jun. 11, 2014
(86) PCT No.: PCT/EP2014/062126

§ 371 Date: Dec. 9, 2015

(30) Foreign Application Priority Data
Jun. 11, 2013 (FR) 1355374

(51) Int. Cl. G09C 1/00

(52) U.S. Cl. CPC G09C 1/00

(57) ABSTRACT

The invention relates to a method for the automatic development, using a programmable device, of a behaviour model for an apparatus providing a cryptographic interface. This method comprises the following steps, carried out by a processor of the programmable device:—obtaining (40) a set of tests to be carried out by the apparatus (30) providing a cryptographic interface,—for each test from the set of tests, a request (42) for performance of that test by the apparatus (30) providing a cryptographic interface and storage of the result of said test,—obtaining (44) a truth table representative of a logic formula for a boolean function from the stored results,—calculating and storing (46) the first entries from the truth table, and—construction and storage (48) of a behaviour model for the apparatus providing a cryptographic interface from the first stored entries.

The present invention relates to a method of automatically developing, with the aid of a programmable device, a behavior model of an apparatus providing a cryptographic interface. The invention also relates to a programmable device for automatically developing a behavior model of an apparatus providing a cryptographic interface, associated therewith, and an associated computer program.

The invention lies in the field of apparatuses providing cryptographic interfaces, and finds a particular application in the field of the validation of reliability and robustness to possible attacks of apparatuses providing a cryptographic interface.

Indeed, apparatuses providing a cryptographic interface are commonly used in numerous fields, such as for example the banking field, and more generally in any application requiring a guarantee of confidentiality of the data to which the apparatus allows access.

Such apparatuses with cryptographic interface generally provide at least one of the following functionalities: cryptographic key generation, encipherment and decipherment, key sharing in a secure manner between several apparatuses. These functionalities are provided by a public interface, according to a cryptographic interface standard, such as for example one of the PKCS standards (“public key cryptography standards”).

The providers of such apparatuses seek to ensure maximum security, so as to avoid any type of hacking of the apparatus making it possible to utilize possible operating flaws to gain unauthorized access to restricted-access data. Hackers do not have the precise specification which underlays the operation of such an apparatus, but only the public interface provided.

It is therefore useful to be able to validate the reliability of an apparatus providing a cryptographic interface solely on the basis of the public interface provided.

In a known manner, a security audit can be performed by experts, who set up ad-hoc security tests. Such a security audit is expensive and its effectiveness is largely dependent on the expert who sets it up.

It is preferable to have automatic tools able to carry out a security audit. Accordingly, a possible solution consists in seeking to model the behavior of the apparatus on the basis of the public cryptographic interface available, and in using the modeling obtained to deduce cryptographic flaws therefrom.

For this purpose, the invention proposes, according to a first aspect, a method of automatically developing, with the aid of a programmable device, a behavior model of an apparatus providing a cryptographic interface. The method of the invention comprises the following steps, implemented by a processor of the programmable device:

obtaining of a set of tests to be executed by the apparatus providing a cryptographic interface,

for each test of the set of tests, requesting the execution of said test by the apparatus providing a cryptographic interface and storing the result of said test,

obtaining of a truth table representative of a logic formula of a boolean function based on the stored results,

computing and storing the prime implicants based on the truth table, and

building and storing a behavior model of the apparatus providing a cryptographic interface based on the stored prime implicants.

Advantageously, the method of the invention makes it possible to automatically develop a behavior model of an apparatus providing a cryptographic interface, this model being particularly reliable by virtue of the use of a computation of the prime implicants.

The method according to the invention can exhibit one or more of the characteristics hereinbelow.

It comprises, furthermore, a step of deleting irrelevant prime implicants before building a behavior model of the apparatus providing a cryptographic interface.

The deleting step comprises the sub-steps of:

building a logic formula for describing the set of tests,

for each stored prime implicant, building an implication logic formula based on the logic formula and on the other prime implicants computed, and

validating of the implication logic formula.

For a processed prime implicant, in case of positive validation of the implication logic formula for said processed prime implicant, said processed prime implicant is labeled as irrelevant.

Furthermore, a prime implicant labeled as irrelevant is deleted from the set of stored prime implicants.

For a processed prime implicant, in case of negative validation of the implication logic formula for said processed prime implicant, said processed prime implicant is labeled as relevant.

Furthermore, a prime implicant labeled as relevant is kept in the set of stored prime implicants.

In the step of building the behavior model of the apparatus providing a cryptographic interface on the basis of the stored prime implicants, said model is built as the conjunction of the set of stored prime implicants.

Moreover, the obtaining of a set of tests to be executed by the apparatus providing a cryptographic interface, comprises a parametrization of a reliability level.

According to a second aspect, the invention proposes a programmable device for automatically formulating a behavior model of an apparatus providing a cryptographic interface. This device comprises:

means for obtaining a set of tests to be executed by the apparatus providing a cryptographic interface,

for each test of the set of tests, means for sending a request for execution of said test by the apparatus providing a cryptographic interface and means for storing the result of said test,

means for obtaining a truth table representative of a logic formula of a boolean function based on the stored results,

means for computing and storing the prime implicants of the logic formula obtained, and

means for constructing a behavior model of the apparatus providing a cryptographic interface based on the stored prime implicants.

The device according to the invention comprises means for implementing all the characteristics of the method of automatically developing a behavior model of an apparatus providing a cryptographic interface according to the invention which are briefly recalled hereinabove.

According to a third aspect, the invention relates to a computer program comprising instructions for implementing the steps of a method of automatically formulating a behavior model of an apparatus providing a cryptographic interface, such as is briefly described hereinabove, during the execution of the program by a processor of a programmable device.

Other characteristics and advantages of the invention will emerge from the description thereof which is given hereinbelow, by way of wholly nonlimiting indication, with reference to the appended figures, among which:

FIG. 1 is a diagram representing the functional blocks of a programmable device able to implement the invention;

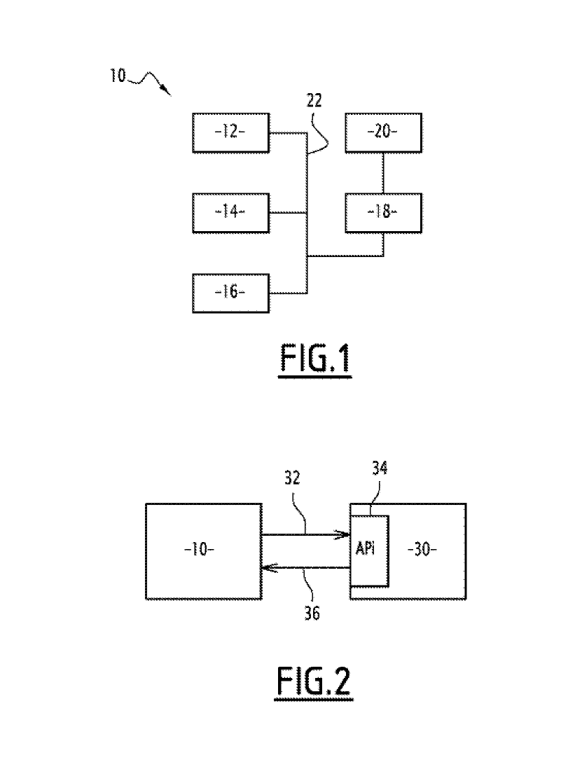

FIG. 2 is a block diagram of a test system for an apparatus providing a cryptographic interface;

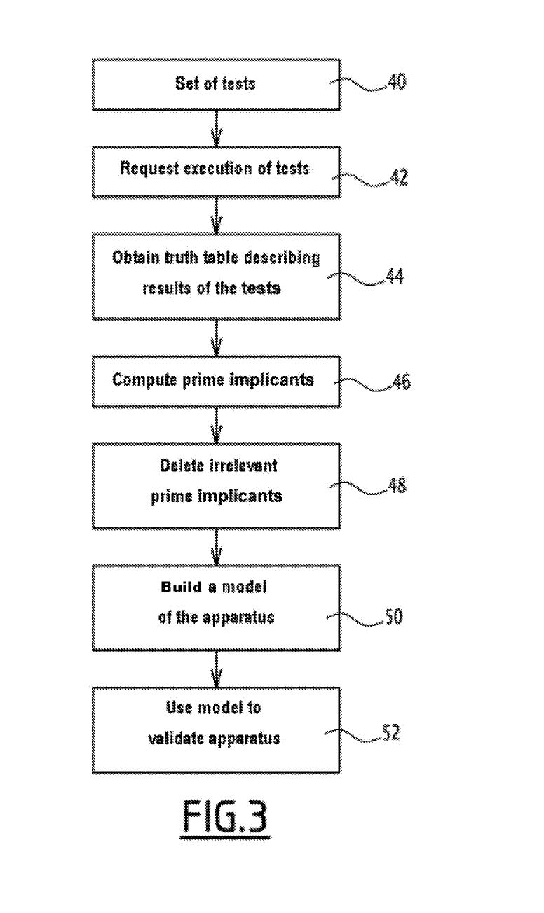

FIG. 3 is a flowchart of a method of automatically developing a behavior model of an apparatus providing a cryptographic interface;

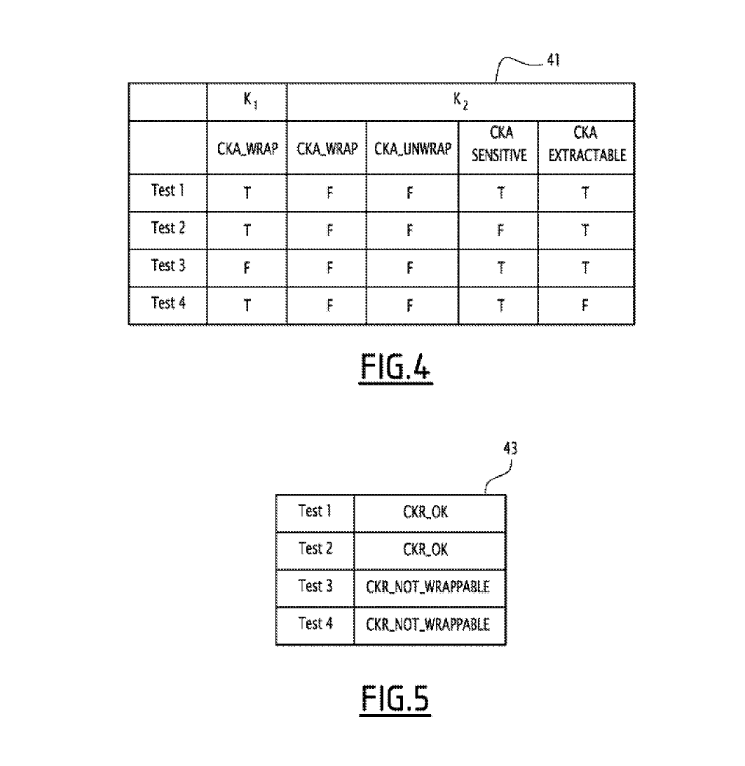

FIGS. 4 to 6 illustrate an example of tests implemented and of result obtained;

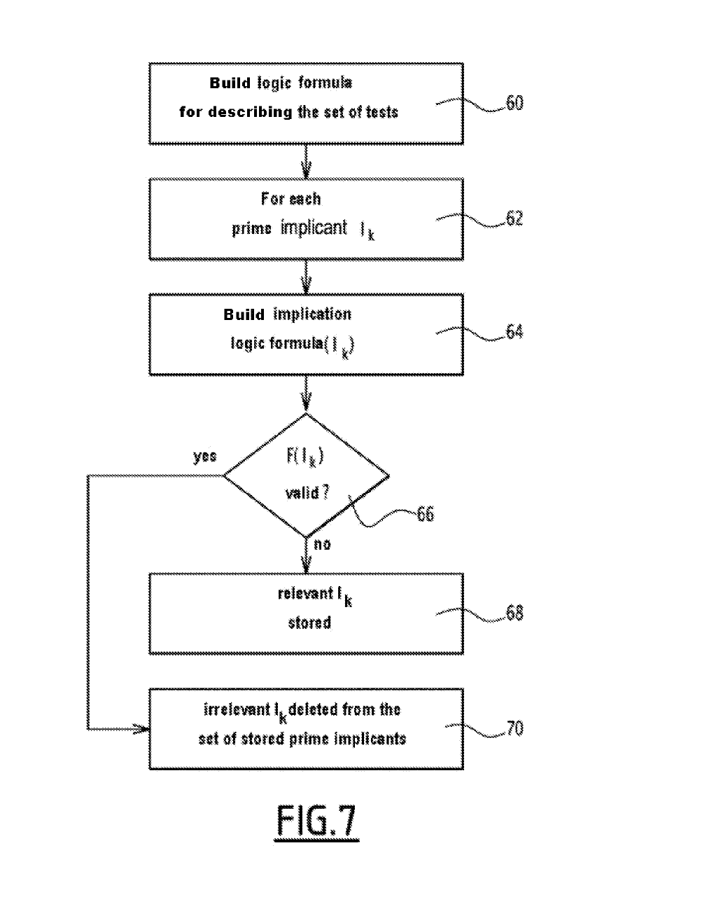

FIG. 7 illustrates the steps implemented for the deletion of irrelevant prime implicants.

FIG. 1 illustrates the main blocks of a device able to implement the method of automatically developing a behavior model of an apparatus providing a cryptographic interface according to the invention.

A programmable device 10 able to implement the invention, typically a computer, comprises a screen 12, a means 14 for inputting the commands of an operator, for example a keyboard, optionally a further pointing means 16, such as a mouse, making it possible to select graphical elements displayed on the screen 12, a central processing unit 18, or CPU, able to execute computer program instructions when the device 10 is powered up. The device 10 also comprises means for storing information 20, for example registers, able to store executable code instructions allowing the implementation of programs comprising code instructions able to implement the method according to the invention. The diverse functional blocks of the device 10 which are described hereinabove are connected via a communication bus 22.

As illustrated in FIG. 2, a test system for an apparatus providing a cryptographic interface comprises a programmable device 10, to which is connected an apparatus providing a cryptographic interface 30. The connecting is performed directly via a wired or remote link, by way of a communication network.

From a functional point of view, the device 10 is able to send requests 32 according to a format defined by a programming interface API 34 of the apparatus providing a cryptographic interface 30, and to receive responses 36.

This exchanging of requests and responses makes it possible, as explained in greater detail hereinafter, to have the apparatus providing a cryptographic interface 30 execute a set of tests and gather a set of test results. These results are processed by the programmable device 10 to obtain a logic formula of a boolean function representative of the behavior of the apparatus with cryptographic interface.

FIG. 3 represents the main steps implemented in a method of automatically developing a behavior model of an apparatus providing a cryptographic interface, which are implemented by a processor 18 of a programmable device 10.

The method is applied for automatically developing a behavior model of an apparatus providing a given cryptographic interface 30.

In a first step 40 of the method, a set of tests of the apparatus 30 is obtained.

This set of tests can be obtained automatically as a function of the standard implemented by the interface API of the apparatus providing a cryptographic interface to be tested, and can be parametrized by an operator. Indeed, depending on the parametrization, the set of tests to be performed is more or less complete. The more complete a set of tests, the higher the reliability level of the behavior model obtained, at the price of a higher computing time. Thus, a compromise between computing time and reliability level is selectable by an operator.

For example, it is possible to test the commands in the case where the value at input possesses exactly 0, 1 or 2 attributes. It is also possible to choose which attributes will be tested by fixing the value of the other attributes, so as to limit the total number of computations to be performed and consequently, to reduce the computation time.

An operator can then parametrize the test level according to the number of attributes tested, corresponding to a given reliability level.

If the apparatus with cryptographic interface 30 provides an interface according to the PKCS#11 standard, a set of normalized commands has to be tested. Each command is parametrized by a set of binary attributes at input, and the result of each command, after execution by the apparatus 30, is also binary. For example, a set of four tests Test1 to Test4, such as illustrated in the array 41 of FIG. 4, is obtained to test the C_Wrap command according to the PKCS#11 standard, which serves to encipher a cryptographic key K1 (“cipher_key”) with the aid of a cryptographic key K2 (“wrapped_key”). In this example, the attribute for the cryptographic key K1 is CKA_WRAP, and the attributes for the cryptographic key K2 are CKA_WRAP, CKA_UNWRAP, CKA_SENSITIVE and CKA_EXTRACTABLE.

For each attribute, the value T for “true” and F for “false” of the attribute is made to vary. For each test Test1 to Test4, the values of the attributes are shown in the columns of the array 41.

Thereafter, in step 42, the device 10 sends commands for executing the tests to the apparatus providing a cryptographic interface 30, and receives a response comprising the result of each test executed by this apparatus. Each result is stored in a memory area 20 of the programmable device 10, for example in the form of an array containing the boolean result of each test executed.

It should be noted that the execution of the tests and the obtaining of the results can be performed either in a sequential manner, or in a grouped manner.

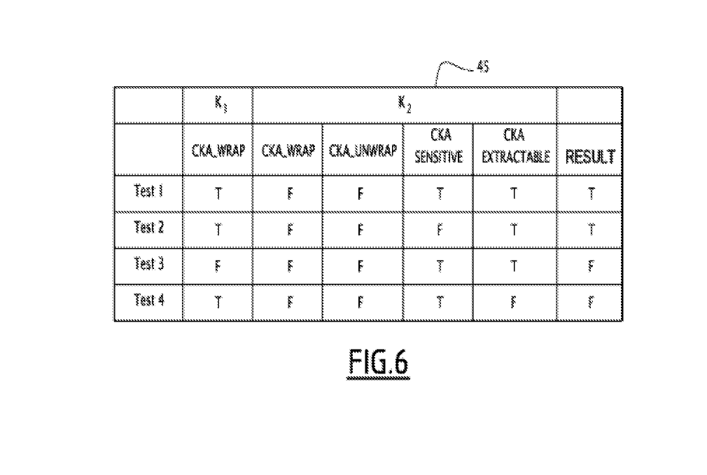

For example, for the set of tests Test1 to Test4 for testing the C_Wrap command, the array 43 of results of FIG. 5 is obtained. The boolean results are respectively the success of the test, that is to say its positive result (CKR_OK) or its failure, that is to say its negative result (CKR_NOT_WRAPPABLE). In the following obtaining step 44, a truth table describing the stored results is obtained. FIG. 6 illustrates the truth table 45 obtained. This truth table 45 is an extension of the array 41 of FIG. 4, to which a “result” column is added. In this new column, the value T for “true” and F for “false” indicates the result, respectively positive or negative, of each test.

In the following computation step 46, the prime implicants of the truth table obtained in the previous step are computed, so as to obtain the elements making it possible to compute the simplest logic formula representative of the behavior of the apparatus providing a cryptographic interface. The known Quine-Mc Cluskey scheme is for example used.

Preferably, the implementation of the scheme for computing the prime implicants is that described in patent EP0568424 B1, included here by reference, using a tree-like representation of a binary decision chart associated with a truth table, and normalized intermediate elements, thus making it possible to reduce memory space consumption when computing the prime implicants.

Any other scheme for implementing a computation of prime implicants making it possible to keep the memory space consumption compatible with the memory space available in the device implementing the invention is usable.

A logic atom is associated with each attribute, for example W1 is associated with CKA_WRAP for K1 (key which enciphers), W2 with CKA_WRAP for K2 (key which is enciphered), U with CKA_UNWRAP, S for CKA_SENSITIVE and E for CKA_EXTRACTABLE.

For the case of the example illustrated in FIGS. 4 to 6, the following prime implicants are obtained on completion of step 46, where [symbol] represents logical “NOT”: W₁, [symbol] W₂, [symbol] ,U,E

These prime implicants express the fact that the attribute CKA_WRAP for the key which enciphers and the attribute CKA_EXTRACTABLE are necessarily T, since none of the tests out of the tests Test1 to Test4 was successful without these attributes, and that the attributes CKA_WRAP and CKA_UNWRAP for the enciphered key must be set to F.

Step 46 of computing the prime implicants is followed by a step 48 of deleting the irrelevant prime implicants.

The objective of this deleting step is to filter the prime implicants obtained previously which are not relevant in relation to the behavior of the apparatus with cryptographic interface but which ensue from the set of tests selected in step 40.

The detail of implementation of step 48 according to an embodiment of the invention is described with reference to FIG. 7.

During a first step 60, a logic formula for describing the set of executed tests is built, independently of the result of each of the tests.

Thus, for the example described hereinabove with reference to the table describing the tests Test1 to Test4, the logic formula is the following where [symbol] represents logical “AND” and [symbol] represents logical “OR”:
FD=(W₁ [symbol] [symbol] W₂ [symbol] [symbol] U [symbol] S [symbol] E) [symbol] (W₁ [symbol] [symbol] W₂ [symbol] [symbol] U [symbol] [symbol] S [symbol] E) [symbol] ( [symbol] W₁ [symbol] [symbol] W₂ [symbol] [symbol] U [symbol] [symbol] U [symbol] S [symbol] E) [symbol] (W₁ [symbol] [symbol] W₂ [symbol] [symbol] U [symbol] S [symbol] [symbol] E)

Thereafter, for each prime implicant Iₖ selected during a step 62, from the prime implicants computed in step 46, an implication logic formula, denoted F(Iₖ), is constructed in step 64.

The implication logic formula is constructed in the following manner. On the left of this formula is the conjunction of FD and of all the prime implicants except Iₖ whose relevance it is sought to estimate. On the right of the implication logic formula is the prime implicant Iₖ whose relevance it is sought to estimate.

Generally:

F(Iₖ):FD [symbol] {Iⱼ, j≠k} [symbol] Iₖ

Thus, going back to the example developed hereinabove, the following implication formulae which are successively constructed are:

F(W₁):FD [symbol] [symbol] W₂ [symbol] [symbol] U [symbol] E [symbol] W₁ for the prime implicant W₁

F( [symbol] W₂):FD [symbol] W₁ [symbol] [symbol] U [symbol] E [symbol] [symbol] ₂ for the prime implicant [symbol] W₂

F( [symbol] U):FD [symbol] W₁ [symbol] [symbol] W₂ [symbol] E [symbol] [symbol] U for the prime implicant [symbol] U

F(E):FD [symbol] W₁ [symbol] [symbol] W₂ [symbol] [symbol] U [symbol] E for the prime implicant E.

For each implication logic formula, the validity of the formula is tested during a validity testing step 66.

If the formula F(Iₖ) is invalid, that is to say if the implication expressed is not satisfied, the prime implicant lₖ is labeled as being relevant and must therefore remain in the set of prime implicants to be used for the building of a model of the apparatus providing a cryptographic interface.

The validity testing step 66 is then followed by step 68 of storing the prime implicant Iₖ.

According to one embodiment, the prime implicants computed during the previous step of computing the prime implicants 46 are already stored, for example in an array, and step 68 does not require any further action.

If the formula F(Iₖ) is valid, that is to say if the implication expressed is satisfied, it is deduced therefrom that the prime implicant Iₖ is a consequence of the choice of the tests performed and of the other prime implicants; therefore it is labeled as irrelevant as regards the modeling of the behavior of the apparatus with cryptographic interface.

In this case, step 66 is followed by a step 70 of deleting the prime implicant Iₖ from the prime implicants stored on completion of the step of computing prime implicants 46. For example, if the prime implicants computed during the previous step of computing the prime implicants 46 are already stored in an array, step 70 consists in erasing the element Iₖ from this array.

In the example considered with the tests Test1 to Test4, the formula F(W₁) is invalid, as is the formula F(E). It is deduced therefrom that the prime implicants W₁ and E are relevant. On the other hand, the formulae F( [symbol] W₂) and F( [symbol] U) are valid; therefore the prime implicants [symbol] W₂ and [symbol] U are not relevant.

Indeed, for example by considering [symbol] W₂, it is clearly apparent that this attribute was never tested with a value T (for “true”); therefore the implicant [symbol] W₂ is a consequence of the choice of the tests.

Returning to FIG. 3, after step 48 of deleting irrelevant prime implicants, a reduced set of relevant prime implicants is preserved. Advantageously, this restricted set makes it possible to accelerate the computations subsequently and to render the result more reliable, by avoiding the use of irrelevant prime implicants which are solely a consequence of the set of tests selected.

Ultimately, the set of remaining prime implicants is used during the following building step 50 for the building of a model of the apparatus providing a processed cryptographic interface.

In one embodiment, the model is expressed as the conjunction of the stored relevant prime implicants.

In the example treated, the model is given by W₁ [symbol] E.

During the step 50 of building a model of the apparatus providing a cryptographic interface, the model is stored in an appropriate format, for example recorded in a text file.

Preferably, the recording uses the cryptographic interface standard, so as to be easily reusable.

In the case of the example treated, the model is for example recorded in the form: CKA_WRAP(cipher key) && CKA_EXTRACTABLE (wrapped_key).

The model thus recorded is thereafter usable during a subsequent step 52 of usage for validation of the apparatus providing a cryptographic interface 30.

For example, by using in model exploration tool (model-checker), it is possible to examine all the possible strings of commands to discover if a sequence exists which compromises the security policy. Each sequence obtained corresponds to a state of the behavior model of the apparatus obtained by the method described hereinabove, and the security policy defines the acceptable or authorized states and the unauthorized states.

It is understood that the example described hereinabove, with reference to FIGS. 4 to 6, is a simplified example with an explanatory aim. In practice, a very broad set of tests is used for the formulation of a behavior model of an apparatus providing a cryptographic interface.

1. A method of automatically developing, with the aid of a programmable device, a behavior model of an apparatus providing a cryptographic interface, characterized in that it comprises the following steps, implemented by a processor of the programmable device:
obtaining of a set of tests to be executed by the apparatus providing a cryptographic interface,
for each test of the set of tests, requesting execution of said test by the apparatus providing a cryptographic interface and storage of the result of said test,
obtaining of a truth table representative of a logic formula of a boolean function on the basis of the stored results,
computing and storing the prime implicants based on the truth table, and
building and storing a behavior model of the apparatus providing a cryptographic interface based on the stored prime implicants.

2. The method as claimed in claim 1, characterized in that it comprises, furthermore, a step of deleting irrelevant prime implicants before the building of a behavior model of the apparatus providing a cryptographic interface.

3. The method as claimed in claim 2, characterized in that the deleting step comprises the sub-steps of:
building of a logic formula for describing the set of tests,
for each stored prime implicant, building of an implication logic formula based on the logic formula and of the other prime implicants computed, and
validating the implication logic formula.

4. The method as claimed in claim 3, characterized in that, for a processed prime implicant, in case of positive validation of the implication logic formula for said processed prime implicant, said processed prime implicant is labeled as irrelevant.

5. The method as claimed in claim 4, characterized in that a prime implicant labeled as irrelevant is deleted from the set of stored prime implicants.

6. The method as claimed in claim 3, characterized in that, for a processed prime implicant, in case of negative validation of the implication logic formula for said processed prime implicant, said processed prime implicant is labeled as relevant.

7. The method as claimed in claim 6, characterized in that a prime implicant labeled as relevant is kept in the set of stored prime implicants.

8. The method as claimed in claim 1, characterized in that in the step of building of the behavior model of the apparatus providing a cryptographic interface based on the stored prime implicants, said model is built as the conjunction of the set of stored prime implicants.

9. The method as claimed in claim 1, characterized in that the obtaining of a set of tests to be executed by the apparatus providing a cryptographic interface comprises a parametrization of a reliability level.

10. A programmable device for automatically formulating a behavior model of an apparatus providing a cryptographic interface, characterized in that it comprises:
means for obtaining a set of tests to be executed by the apparatus providing a cryptographic interface,
for each test of the set of tests, means for sending a request for execution of said test by the apparatus providing a cryptographic interface and means for storing the result of said test,
means for obtaining a truth table representative of a logic formula of a boolean function based on the stored results,
means for computing and storing the prime implicants of the logic formula obtained, and
means for constructing a behavior model of the apparatus providing a cryptographic interface based on the stored prime implicants.

11. A computer program comprising instructions for implementing the steps of a method of automatically formulating a behavior model of an apparatus providing a cryptographic interface as claimed in claim 1 during the execution of the program by a processor of a programmable device.
